(19) United States
(12) Patent Application Publication
(10) Pub. No.: US 2024/0000066 A1
(43) Pub. Date: Jan. 4, 2024

(54) PERFUSION SYSTEM

(71) Applicant: Vascular Perfusion Solution, Inc., San Antonio, TX (US)

(72) Inventor: Israel Jessop, Garden Ridge, TX (US)

(21) Appl. No.: 18/254,231

(22) PCT Filed: Nov. 24, 2021
(86) PCT No.: PCT/US2021/060770

§ 371 Date: May 24, 2023

Related U.S. Application Data
(60) Provisional application No. 63/118,497, filed on Nov. 25, 2020.

(51) Int. Cl. A01N 1/02

(52) U.S. Cl. CPC A01N 1/0247

(57) ABSTRACT

The present disclosure relates to a perfusion system (300) that comprises a housing (311) containing a head unit (310), a cannister (340), a pressurization component (344), and a cannula (360). The head unit comprises an oxygenator (312) and a perfusion pump, wherein the perfusion pump may comprise a pump chamber (320) with an inlet valve (322) and an outlet valve (324), and a diaphragm (328). The system (300) can be connected to an oxygen source, such as an oxygen concentrator, and can be used to circulate perfusate fluid through a target tissue (390) or organ in the cannister to provide oxygen to the tissue. The oxygen source can provide gas to a pressure regulator, which can provide a constant gas pressure against the cannister pressurization component, which can e.g. be a diaphragm or a balloon element, in order to control and maintain cannister pressure at a preset value.

### CROSS-REFERENCE TO RELATED APPLICATION

This application claims the benefit of priority to U.S. Provisional Patent Application Ser. No. 63/118,497 filed Nov. 25, 2020, the contents of which are incorporated herein by reference in their entirety.

### BACKGROUND

Perfusion includes the passage of fluid through the circulatory system or lymphatic system of an organ or tissue. In the human body, perfusion often refers to passage of blood through a capillary bed in tissue. Perfusion can allow for the delivery of oxygen, other dissolved gases, nutrients, and other items to the tissue. When tissue or an organ is not residing in the body, such as during transport of an organ for transplant, perfusion does not naturally occur.

### SUMMARY OF THE DISCLOSURE

Disclosed is an organ perfusion system used to maintain organ or other tissue viability during transport interval. The system includes a cannister pressurization system that allows for regulated pressure within the system when in transit or while the organ or another tissue is waiting to be given to the recipient. The system can optionally have an inner lid to better maintain sterility of the device and organ being transported.

Conventional perfusion systems can use an electric pump to circulate the perfusate. These pumps can be large and inefficient. In the systems and methods discussed herein, the oxygen source itself can be used in an integrated system to pressurize and pump the device, in conjunction with a pressurization system such as a multi-way valve and flexible diaphragm. This can allow for more compact and efficient perfusion systems for transport of tissue or organs.

In an example, a perfusion system can include a head unit, a cannister, a cannister pressurization component, and a cannula. The head unit can be for circulating a perfusate. The head unit can include an oxygenator, a filter, and a perfusion pump. The oxygenator can be for oxygenating the perfusate and be configured to receive oxygen from an oxygen source. The filter can be for removal of solid particulate that may be present in the perfusate. The perfusion pump can be for circulating the perfusate through the system. The cannister can be releasably coupled to the head unit, and the cannister sized and shaped for receiving a target tissue. The cannister pressurization component can be for maintaining pressure in the cannister. The cannula can fluidly couple the head unit to the target tissue, and the cannula can be for introducing the perfusate from the head unit to the target tissue in the cannister.

In an example, a perfusion system can include a head unit, a cannister, a cannister pressurization component, and a cannula. The head unit can be for circulating a perfusate. The head unit can include an oxygenator and a perfusion pump. The oxygenator can be for oxygenating the perfusate and be configured to receive oxygen from an oxygen source. The perfusion pump can be for circulating the perfusate through the system. The perfusion pump can include a pump chamber for collecting oxygenated perfusate from the oxygenator, a valve for regulating pressure in the cannister pressurization system, and a diaphragm for pressurizing the pump chamber and circulating the perfusate through the system from the pump chamber to the cannister. The cannister pressurization component can be for maintaining pressure in the cannister. The cannula can fluidly couple the head unit to the target tissue, and the cannula can be for introducing the perfusate from the head unit to the target tissue in the cannister.

In an example, a method of perfusing target tissue can include: oxygenating perfusate liquid in an oxygenator; pumping the oxygenated perfusate liquid to a de-pressurized pump chamber; pressurizing the pump chamber to pump the oxygenated perfusate through a cannula to the target tissue in a cannister; and oxygenating the target tissue and de-oxygenating the perfusate fluid.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1C are schematic diagrams of a perfusion system at rest and in use.

FIGS. 1D-1F show examples of valve positions and perfusate flow.

FIG. 2 is a schematic diagram of a perfusion system centrally aligned.

FIGS. 3A-3B are schematic diagrams of a perfusion system with an inner lid.

### DETAILED DESCRIPTION

The present disclosure describes, among other things, a perfusion system and methods for maintaining and prolonging organ viability during the transport interval, after removal from a donor but before transplantation into an organ recipient.

Once separated from a living body, organs, limbs and other vascularized tissues may be oxygenated, and metabolic waste products removed, to maintain viability of those tissues beyond the medically established cold ischemic time. Perfusion is a possible method to prolong organ viability outside the body. Perfusion systems can pump an oxygen-enriched liquid through the vasculature (e.g., arteries, capillaries, and veins) of tissue. Moreover, perfusion can deliver nutrient gas, such as oxygen, and metabolic substrates, such as glucose, to metabolically active cells and simultaneously remove metabolic waste gas, such as carbon dioxide.

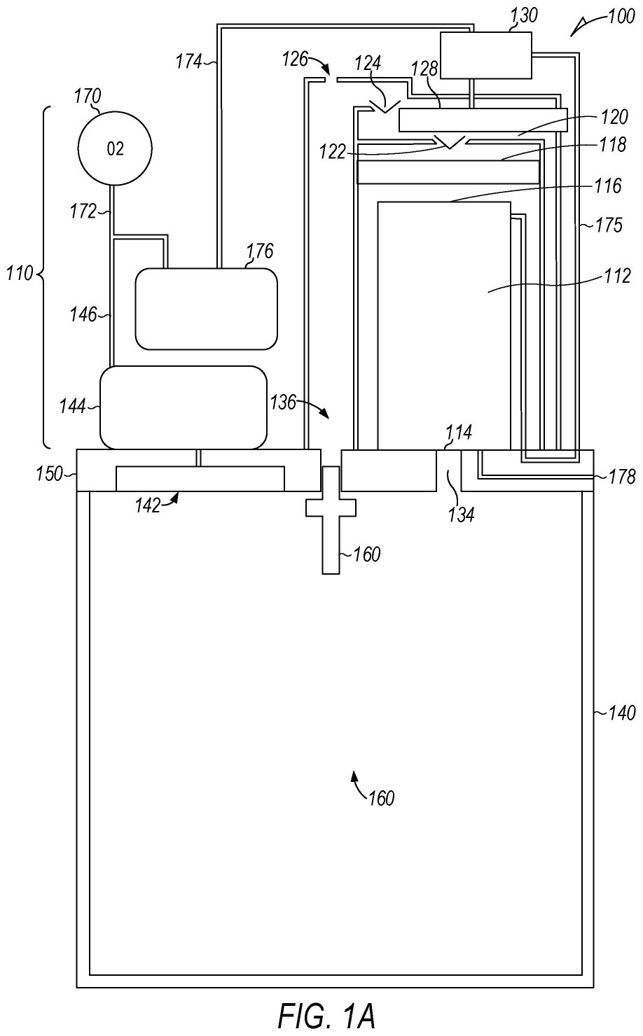

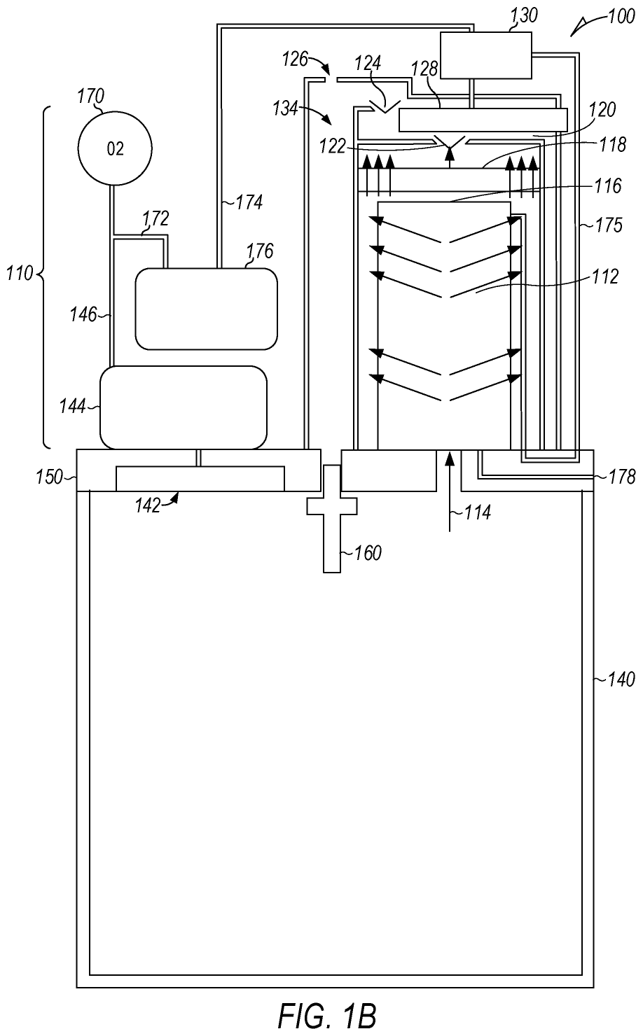

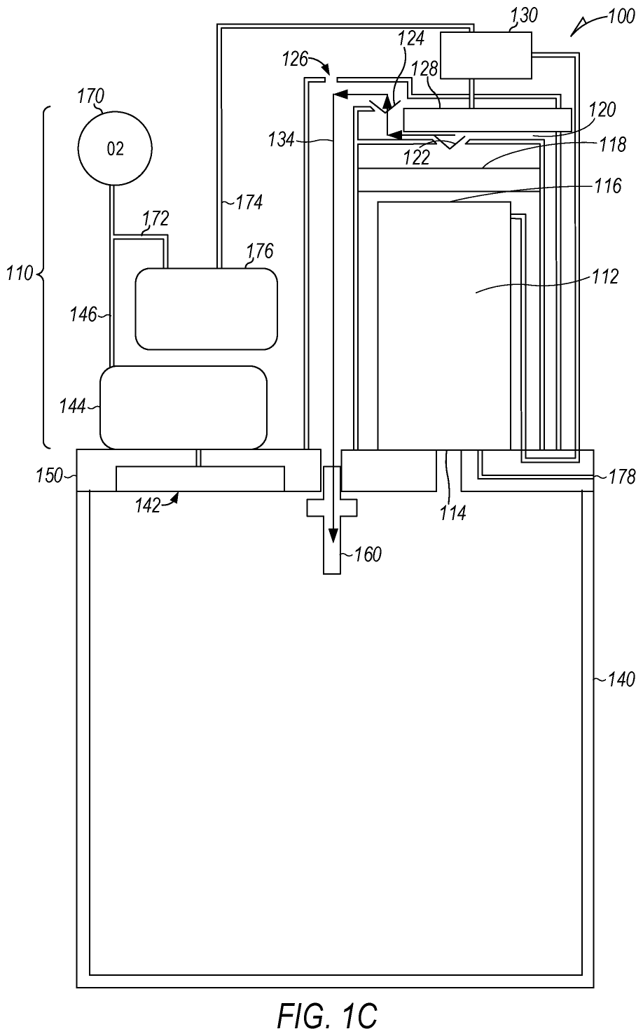

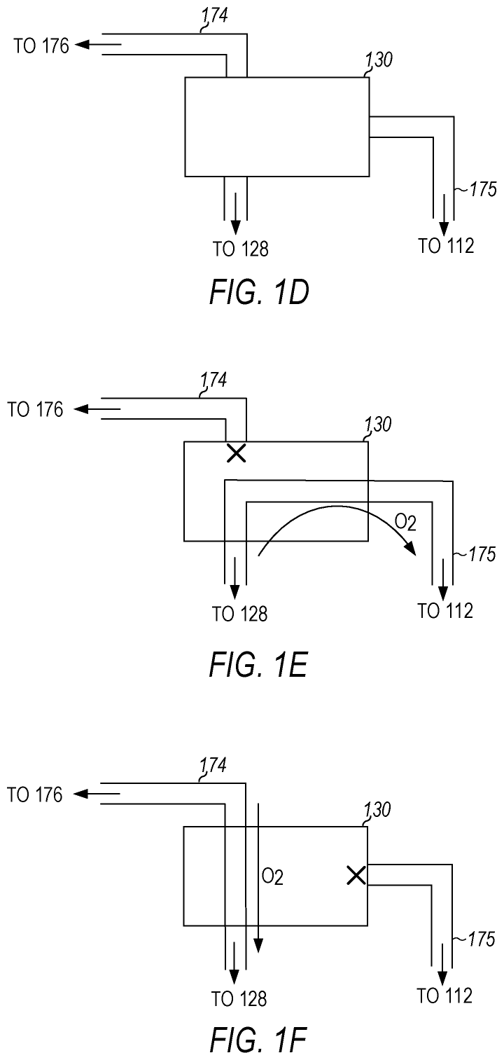

FIGS. 1A-1C are schematic diagrams of a perfusion system 100. In FIG. 1A, the system 100 can be at rest. In FIGS. 1B and 1C, the system 100 can be in use. The system 100 can include a head unit 110 with an oxygenator 112 with inlet 114 and outlet 116, a filter 118, a pump chamber 120 with inlet valve 122 and outlet valve 124, vent 126, a diaphragm 128, a three-way valve 130, perfusate lines 134 and 136, a cannister 140 with cannister pressurization component 142, a cannister pressurization regulator 144, and a pressure regulator line 146, a base plate 150 and a cannula 160. The system 100 can be connected to an oxygen source 170 with oxygen lines 172, 174, 175, a pump pressure regulator 176, and a vent 178.

The system 100 can be used to circulate perfusate fluid through a target tissue or organ in the cannister 140 to provide oxygen to the tissue. The perfusate fluid can be a perfusate, blood, saline, fluid specifically formulated for organ preservation or perfusion, or some other appropriate fluid for perfusion of an organ or target tissue in the cannister 140. The fluid can be, for example, oxygen-enriched fluid or blood-based fluid, to provide oxygen to the target tissue, organ, or limb. For example, the organ can be a heart, lung, kidney, or other vascular tissue requiring oxygenation while outside the body. The perfusion circuit can include, for example, tubing, piping, or hosing, to carry the perfusate fluid between one or more fluid reservoirs, and the cannister 140.

In system 100, the head unit 110 can house components for circulation of perfusate liquid and oxygen throughout the system 100. The head unit 110 can include the oxygenator 112, the, filter 118, and the perfusion pump chamber 120, encapsulated by an optional housing (not shown). The head unit 110 can be connected to the cannister 140, such as through the base plate 150. The cannula 160 may fluidly connect the head unit 110 to a cannulated organ or target tissue located in the cannister 140 by allowing flow of perfusate therebetween. The oxygen source 170 can be in fluid communication with the head unit 110 to allow flow of oxygen, and allow for pressurization of the head unit 110 and the cannister 140.

The head unit 110 can house the oxygenator 112, the filter 118, the pump chamber 120, and the three-way valve 130. The head unit 110 can include an optional housing for encapsulating or covering the components, such as a metallic, composite, or plastic material, for at least partially enclosing and protecting the components in the head unit 110. The head unit 110 can be shaped, sized, or arranged for optimal layout of the components in the head unit 110 while allowing for pumping of perfusate and oxygen through the system 100.

The oxygenator 112 can be configured to exchange oxygen and carbon dioxide in perfusate fluid. The oxygenator 112 can include a perfusate inlet 114 for incoming de-oxygenated perfusate from the cannister 140, and a perfusate outlet 116, wherein outgoing oxygenated perfusate can exit the oxygenator 112. The oxygenator 112 can be secured within the head unit 110, such as to a base plate.

The oxygenator can be fluidly coupled to the oxygen source 170. The oxygen source 170 can be an oxygen concentrator, an oxygen generator, tank of pressurized oxygen, or other appropriate oxygen source, such as a hook-up. The oxygen source 170 can provide oxygen to the organ preservation system 100 and provide a pressure gradient to the system 100 to induce flow of a perfusate fluid therethrough.

For example, the oxygen source 170 can be an oxygen concentrator that can filter surrounding air, compress that air to a specified density, and deliver purified oxygen in a pulsatile fashion, or in a continuous stream. Such an oxygen concentrator can be fitted with filters and/or sieve beds to remove nitrogen and other elements, gases, or contaminants from the air. In an example, the oxygen concentrator can include a pressure swing adsorption system, such as the Invacare® Platinum Mobile oxygen concentrator (Invacare Corporation, Elyria, OH). A pressure swing adsorption oxygen concentrator can leverage a molecular sieve to absorb gases and operate using rapid pressure swing adsorption to capture atmospheric nitrogen in minerals, such as zeolite, and subsequently vent that nitrogen, operating in a manner that is similar to a nitrogen scrubber. This can allow other atmospheric gases to exit the system, leaving oxygen as the primary remaining gas. Conventional oxygen concentrators can include an air compressor, the molecular sieve or alternatively a membrane, a pressure equalizer, and various valves and tubes to accomplish these functions. Other types or configurations of oxygen concentrators or oxygen sources are also envisioned herein.

In some cases, the oxygen source 170 can be an oxygen generator. In this context, an oxygen generator can produce molecular oxygen (02 gas) by reaction of other chemical components. Examples of oxygen-generating chemical reactions can include thermal decomposition of chlorate or perchlorate salts, hydrolysis of potassium superoxide, enzyme (catalase)—mediated decomposition of hydrogen peroxide, electrolysis of water, or other appropriate reactions.

The pressure of the oxygen provided by the oxygen source 170 can be regulated by pump pressure regulator 176. The pressure can be about, for example, 75 mm Hg. A portion of the oxygen can go down line 146 to pressurize the cannister pressurization component 142 and maintain pressure in the cannister 140. The oxygen source 170 can be fluidly coupled to the oxygenator 112 through oxygen line 174 and three-way valve 130 to provide oxygen for oxygenation of perfusate running through the oxygenator 112 as will be discussed in greater detail below. Also waste gas can be vented out of the oxygenator at vent line 178. The pressure of the oxygen source 170 can also be regulated by the cannister pressure regulator 144, to about, for example, 25 mm Hg. The internal pressure of cannister 140 can be controlled by adjusting cannister pressure regulator 144, with pressure values always positive with respect to atmospheric pressure, and negative with respect to regulated pump pressure.

In the oxygenator 112, de-oxygenated perfusate fluid from the cannister 140 can enter through the inlet 114. The perfusate can run up through the oxygenator towards the outlets 116. While in the body of the oxygenator, the perfusate can be oxygenated. For example, the oxygenator 112 can be a hollow cylinder with a central lumen that the perfusate runs through. The cylinder of the oxygenator can include one or more structures or components that allow for dissolution of oxygen within the perfusate. The oxygen and the perfusate within the oxygenator 112 can run in directions opposite each other, to create a counter-current flow. Such a counter-current flow can increase the gradient and the oxygenation of the perfusate by diffusion of oxygen gas therein.

The filter 118 can be, for example, a plate filter across the outlet 116 of the oxygenator 112, so that oxygenated perfusate leaving the oxygenator 112 can be filtered for impurities before being cycled back towards the cannister 140. The filter can be used leading into or out of the tissue container 140 of the organ preservation system 100. The filter can include, for example, a particulate filter, a filter for removing contaminants in the perfusate fluid, a filter directed to chemicals or dissolved gases, or any other type of appropriate filter for treatment of the perfusate fluid. In any example of the portable oxygen source and perfusion system disclosed herein, multiple filters can be used. In some cases, a filter can be upstream of the tissue container of the organ preservation system 100 so as to filter the perfusate fluid prior to reaching the tissue or organ being perfused. In some cases, the filter can be downstream of the tissue container of the organ preservation system 100 so that fluid returning to the tissue container reservoir is filtered.

The oxygenated perfusate can flow out of the oxygenator 112 through the filter 118 into the pump chamber 120. The pump chamber 120 can have an inlet valve 122 and an outlet valve 124, which can be check valves. The diaphragm 128 in the pump chamber 120 can be de-pressurized to allow flow of the oxygenated perfusate into the pump chamber 120. The oxygenated perfusate can flow into the pump chamber 120 through the inlet valve 122, and fill the pump chamber 120 partially or fully. The oxygenated perfusate can remain in the pump chamber 120 until it is pumped out towards the cannister 140.

The diaphragm 128, located in the pump chamber 120, can be pressurized to pump perfusate out of the pump chamber 120, through the outlet valve 124, and towards the target tissue in the cannister 140 via line 136. Articulation of the diaphragm 128 can allow pumping of the perfusate out of the pump chamber 120.

The three-way valve 130 can be a controllable solenoid valve situated in the oxygen line 174 between the oxygen regulator 176 and the oxygenator 112. The three-way valve 130 is also between line 174 and diaphragm 128. Valve 130 may be fluidly coupled to the diaphragm 128. The three-way valve 130 can alternate between a first position and a second position as shown in FIGS. 1D-1F.

FIG. 1D highlights the fluid lines into and out of valve 130. Here, oxygen is delivered to valve 130 via line 174. Oxygen then flows out of valve 130 to diaphragm 128 or to oxygenator 112 via line 175 depending on the valve position.

FIG. 1E shows that when the valve 130 is in the first position, oxygen is prevented from flowing into the valve 130 from the oxygen line 174 and reaching diaphragm 128 as indicated by the X and any oxygen already in the diaphragm is driven from the pressurized diaphragm through the valve body and out line 175 to oxygenator 112 for oxygenation of incoming perfusate from cannister 140. Thus, in this example the oxygen source 170 is never directly coupled to the oxygenator. Flow of the oxygen is indicated by the arrow labeled O₂.

FIG. 1F shows that in the second position, the three-way valve 130 can pressurize the diaphragm 128 to allow pumping of oxygenated perfusate out of the pump chamber 120 towards the cannister 140 to oxygenate the tissue in the cannister 140 via fluid path 160. Flow of oxygen from the valve input toward the diaphragm is indicated by the arrow labeled O₂. Oxygen from the diaphragm is prevented from flowing to the oxygenator along line 175 as shown by the X. The second position can be when the diaphragm 128 is pressurized. When the three-way valve 130 alternates between the first position and the second position, the pressure pumps throughout the system 100 in a pulsatile fashion, such as imitating a heartbeat. The alternating first and second positions can be scheduled and regulated to create phases of pressurization and depressurization of the diaphragm 128 to pump perfusate through the system 100.

In system 100, shown in FIGS. 1A-1C, the upward-facing orientation of the valves 122, 124, in the pump chamber 120, can facilitate purging of residual air from the system 100 during pump priming and use. The residual air, gas, or bubbles can be released up through the valves 122, 124, towards the vent 126 before the oxygenated perfusate is pumped back around to the cannister 140 via line 136. The upward facing pump exit ports also allow prompt ejection of any gas bubbles that may form or collect within the pump chamber 120. The purge port vent 126 can be located at the highest point of the entire fluid circuit, to collect and remove gas from the system and vent the gas to the atmosphere.

FIGS. 1B to 1C show the system 100 in both pressurization and depressurization phases. The oxygenator 112, pump chamber 120, three-way valve 130, and other components of the pressure regulation system can be part of the head unit 110, and encased in the housing (not shown). The oxygenator 112 can be affixed to a base plate 150, where the oxygen-depleted perfusate enters the central lumen of the oxygenator 112. The oxygenator can be enclosed within a hollow cylinder or other tubular shape that contains the oxygenated outflow from the oxygenator 112 and directs it upward through the disc filter 118. After filtration, during phases of pump diaphragm depressurization, the perfusate can flow upward through the first one-way valve 122 into the diaphragm pump chamber 120, as shown in FIG. 1B. When the pump diaphragm 128 pressurizes and expands, it can expel perfusate upward through the second one-way valve 124 into the arterial line, as shown in FIG. 1C. From the arterial line, the oxygenated perfusate can flow through the base plate 150 and the cannula 160 to enter the target tissue or organ. As previously discussed, the positions of valve 130 are shown in FIGS. 1D-1F. Flow to the cannula 160 occurs when valve 130 has the position illustrated in FIG. 1F, and flow to oxygenator occurs when the valve 130 has the position illustrated in FIG. 1E.

The cannister 140 can be a container for the target tissue or organ being perfused. For example, the cannister 140 can contain the perfusate and a heart (or other organ or tissue), coupling with the head unit to form a sterile barrier around the organ, enclosing it within a fluid-tight container. The cannister 140 can provide a sterile environment in which to transport and perfuse the target tissue and organ; the cannister 140 can be filled with a perfusate liquid in which the target tissue or organ resides. The cannister 140 can create a seal with the base plate 150, and be fluidly connected to the components of the head unit 110 through the cannula 160 and the base plate 150. The seal can be created by attachment mechanisms, such as threading, a snap fit, a press fit, O-rings, or other sealing attachments to allow for a liquid-tight seal.

The cannister can be pressurized by the cannister pressurization component 142, which can be, for example, a diaphragm located in the cannister 140. The cannister pressurization component 142 can be in direct contact with the fluid volume of the cannister. The cannister pressurization component 142, with the pressure regulator 144, can be part of a cannister pressurization system that can control and maintain cannister pressure at a preset value, to ensure return of oxygen-depleted perfusate from the cannister back into the head unit 110, during the depressurization phase of the diaphragm pump cycle. The continuously maintained, positive cannister pressure can provide for robust pump operation at all orientations without regard for head pressure.

In the cannister pressurization system, the oxygen source 170 can provide gas to the pressure regulator 144, which can provide a constant gas pressure against the cannister pressurization component 142. The constant pressure can be, for example, about 25 mm Hg with respect to atmospheric pressure. A constant pressure above the cannister pressurization component 142 can help maintain a constant pressurization of the liquid under the diaphragm, e.g., the cannister pressure. The cannister pressurization component 142 can be made of a flexible material to allow for fluctuations in the volume of fluid in the cannister, such as an influx and outflux of the fluid from the cannister as the system 100 cycle pumps. This can help avoid hydraulic push-back or a dramatic increase in cannister pressure. In some cases, the cannister pressurization component 142 can act as an accumulator in the hydraulic sense, or as a pneumatic spring for control of volumetric compliance within the cannister 140 volume.

In some cases, the cannister pressurization component 142 can be replaced with a balloon element to provide pressurization to the cannister 140. In this case, the inner volume of the balloon can be fluidly coupled to an external gas pressure regulator. In some cases, the cannister 140 pressurization can be maintained by an elastic diaphragm, a spring-coupled diaphragm, or a spring-coupled sliding piston.

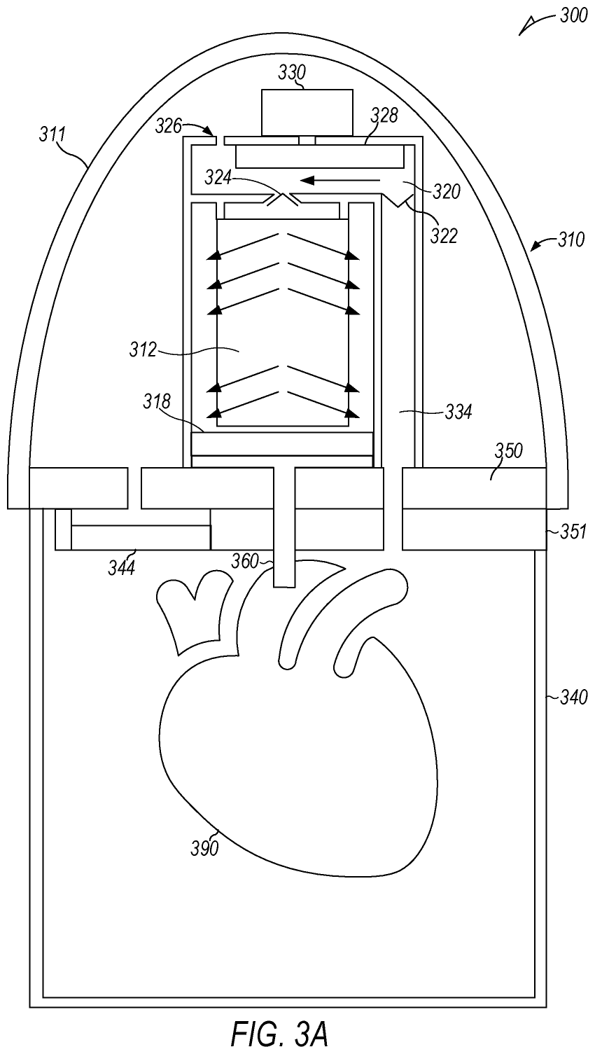

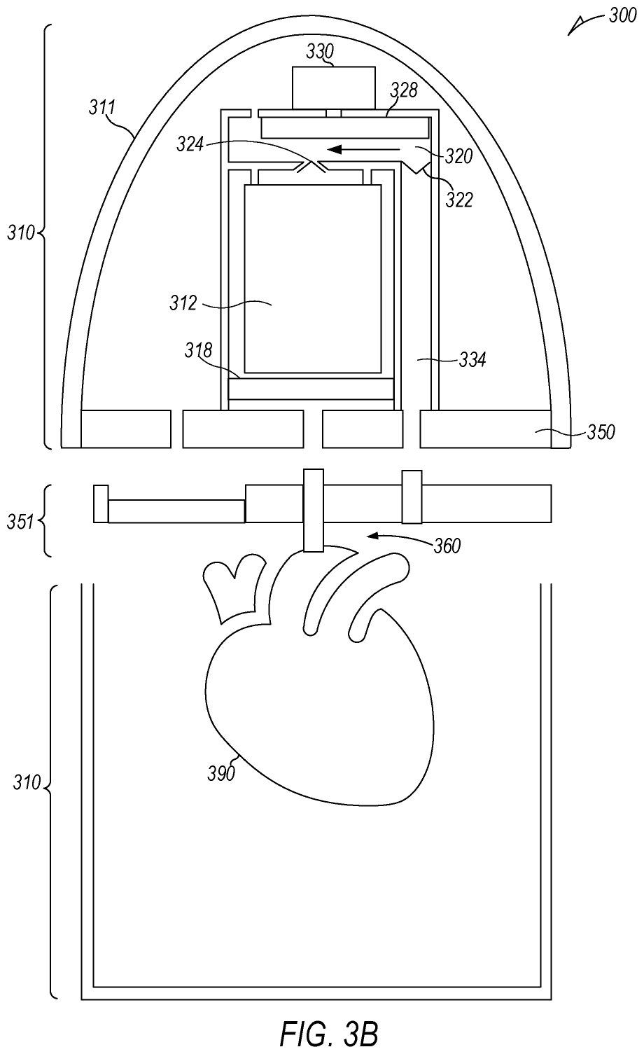

The base plate 150 between the cannister 140 and the head unit 110 can separate the two. The base plate 150 can additionally mediate fluid transport between the head unit 110 and the target tissue or organ, and back into the head unit 110. In some cases, an additional inner lid can be included adjacent to the base plate 150. An example of an inner lid is discussed in detail with reference to FIG. 3 below.

The cannula 160 can allow for a cannula to fluidly connect the head unit 110 to the target tissue through the base plate 150. For example, where a heart is being transported and perfused, the cannula 160 can include a cannula that can fluidly couple the aorta of the donor heart to the output of the head unit, and also support the weight of the donor heart during transfer to the sterile surgical field.

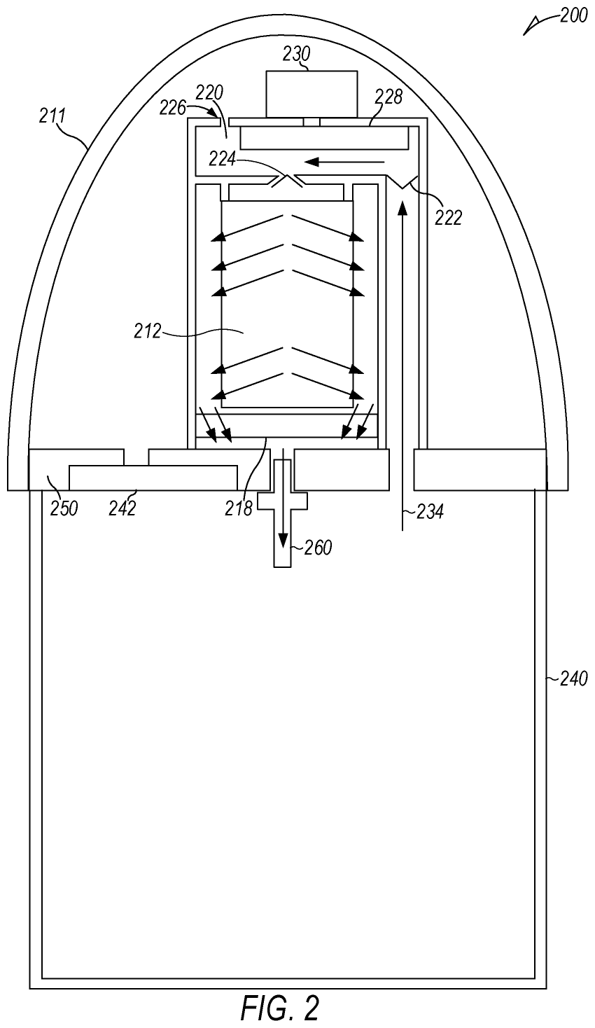

FIG. 2 is a schematic diagram of a perfusion system 200 where the perfusate output to the cannister is centered over the cannister and target tissue. The system 200 can include a head unit 210 with housing 211, an oxygenator 212, a filter 218, a pump chamber 220 with inlet valve 222 and outlet valve 224, vent 226, a diaphragm 228, a three-way valve 230, perfusate line 234, a cannister 240 with a cannister pressurization component 244, a base plate 250, and a cannula 260. The system 200 can be connected to an oxygen source (not shown). The components of system 200 can be similar to those of system 100, except where otherwise noted.

In system 200, the oxygenator 212 and pump chamber 220 can be centered in the housing 211 of the head unit 210. In this arrangement the oxygenator 212 and the filter 218 can be downstream of the pump chamber 220. The housing 211 can be a cover over the top of the head unit 210, for cosmetic and protective purposes.

In system 200, the order of components in the head unit is opposite to system 100 previously described. In system 200, the deoxygenated perfusate exits the target tissue through the cannister 240 and runs up through the perfusate line 234, through the valve 222, into the pump chamber 220. When pressurized, the diaphragm 228 distends and pushes the perfusate out the valve 224 into the oxygenator 212. The perfusate is oxygenated in the oxygenator 212 as it runs down through to the filter 218, and out a cannula in the cannula 260 back to the target tissue in the cannister 240. In this way, the upward flow of perfusate from the cannister 240 towards the pump chamber 220 can activate a rotameter-type visual flow indicator with each pulse of the pump cycle.

FIGS. 3A-3B show schematic diagrams of a perfusion system 300 with an inner lid 351, below and separate from the base plate 350. The system 300 can include a head unit 310 with housing 311, an oxygenator 312, a filter 318, a pump chamber 320 with inlet valve 322 and outlet valve 324, vent 326, a diaphragm 328, a three-way valve 330, perfusate line 334, a cannister 340 with a cannister pressurization component 344, a base plate 350, an inner lid 351, and a cannula 360. The system 300 can be connected to an oxygen source (not shown). The target tissue or organ 390 is shown in FIGS. 3A-3B. The components of system 300 can be similar to those of system 100 above, except where otherwise noted.

The inner lid 351 is shown detached from the head unit 310 in FIG. 3B. The target tissue 390, in this illustration a heart, is secured to the inner lid 351. The inner lid 351, which resides between the head unit 310 and the cannister 340, can fluidly couple the target tissue 390 to the output of the head unit 310, and channel fluid from the cannister 340 back to the head unit 310 for recirculation.

The cannister pressurization component 344 can be located on the inner lid for cannister pressurization. The cannister pressurization component 344 can be in direct contact with the cannister 340 volume, and pressurized from above by a gas channel that runs through the base plate of the head unit 310.

A disassembled system 300 is shown in FIG. 3B. Here, for the purpose of sterile presentation to the surgical field, the inner lid 351 with the target tissue 390 can be separated from the head unit 310. After transportation in the carrying case, the outer surfaces of the head unit 310 is no longer sterile. For a sterile transfer of the target tissue 390, the assembly system 300 can be placed on a non-sterile table, and the head unit 310 can be removed and set aside using non-sterile hands. The inner lid 351 can remain sterile and can be removed from the cannister using sterile hands with the target tissue 390 attached. The inner lid 351 with the attached target tissue 390 can be transferred to a sterile field for surgical preparation.

For purposes of this disclosure, “sterile” can include sufficiently free from bacteria or other living microorganisms; and suitable for use in organ transplant procedures, such as in a surgical environment. In the case of the device being supplied sterile in its package prior to opening, at least some portions of the device are terminally sterilized using methods known in the art (e.g. plasma sterilization, E-beam, gamma radiation, ethylene oxide, etc.) to have a sterility assurance level (SAL) of at least 10′. Once the device has been removed from its packaging it should be handled aseptically or in a manner consistent with standard surgical sterile techniques to avoid contamination of the device.

Fluid connections between the head unit 310 and the inner lid 351 can be designed with internal valves that can remain closed when the two portions are separated, but opened when the system 300 is fully assembled. This can allow for retention of fluids within the head unit 310 to avoid spillage when the system 300 is disassembled.

### Various Notes & Examples

Each of these non-limiting examples can stand on its own, or can be combined in various permutations or combinations with one or more of the other examples.

Example 1 can include a perfusion system comprising a housing containing a head unit configured to circulate a perfusate, a cannister releasably coupled to the housing, the cannister having a receptacle sized and shaped for receiving a target tissue, a cannister pressurization component fluidly coupled with the cannister and configured to maintain pressure in the cannister, and a cannula fluidly coupled with the head unit and the target tissue, the cannula configured to introduce the perfusate from the head unit to the target tissue in the cannister. The head unit can include an oxygenator disposed in the housing and configured to oxygenate the perfusate, the oxygenator configured to be fluidly coupled with an oxygen source and configured to receive oxygen therefrom and a perfusion pump disposed in the housing and operably coupled with the oxygenator and configured to circulate the perfusate through the oxygenator.

Example 2 can include Example 1, wherein the perfusion pump comprises: a pump chamber for collecting oxygenated perfusate from the oxygenator; a valve fluidly coupled to the pump chamber, the valve configured to regulate pressure in the pump chamber; and a diaphragm operably coupled with the pump chamber and configured to pressurize the pump chamber, the diaphragm configured to circulate the perfusate through the system from the pump chamber to the cannister.

Example 3 can include any of Examples 1-2, wherein the valve is fluidly connectable to the oxygen source and the pump diaphragm.

Example 4 can include any of Examples 1-3, wherein the valve comprises at least one moveable element that can move alternately between: a first position, wherein the valve de-pressurizes the diaphragm to allow flow of oxygen from the pump chamber to the oxygenator; and a second position opposite the first position, wherein the valve pressurizes the diaphragm and induces circulation of oxygenated perfusate out of the pump chamber to the cannister via the cannula.

Example 5 can include any of Examples 1-4, wherein the head unit further comprises a filter fluidly coupled with the oxygenator and configured to filter the perfusate.

Example 6 can include any of Examples 1-5, wherein the oxygenator is configured to receive oxygen-depleted perfusate from the cannister through the filter.

Example 7 can include any of Examples 1-6, wherein the oxygenator is configured to receive oxygen-depleted perfusate from the cannister, oxygenate the perfusate, and return the oxygenated perfusate to the target tissue via the cannula.

Example 8 can include any of Examples 1-7, wherein the cannula is configured to be fluidly coupled to the target tissue and configured to support the weight of the target tissue when the target tissue is removed from the cannister.

Example 9 can include any of Examples 1-8, further comprising a base plate and a sealing element disposed between the cannister and the head unit, the base plate and sealing element forming a fluid tight seal therebetween.

Example 10 can include any of Examples 1-9, further comprising an inner lid separating the head unit from the cannister, the inner lid releasably coupled to the cannister.

Example 11 can include any of Examples 1-10, wherein the inner lid comprises a wall defining an aperture therethrough, and wherein the cannula is disposed in the aperture.

Example 12 can include any of Examples 1-11, wherein the inner lid allows sterile access to the cannister, and wherein the inner lid supports weight of the target tissue.

Example 13 can include any of Examples 1-12, wherein the target tissue comprises a heart, a limb, a lung, a kidney, a liver, or other tissue.

Example 14 can include any of Examples 1-13, wherein the cannister pressurization component comprises a diaphragm operably coupled with the cannister.

Example 15 can include any of Examples 1-14, wherein the cannister pressurization component is configured to be pressurized by an external pressure source.

Example 16 can include any of Examples 1-15, further comprising an oxygen source fluidly coupled to the head unit.

Example 17 can include any of Examples 1-16, wherein the cannister pressurization component is fluidly coupled to the oxygen source to allow pressurization thereof.

Example 18 can include any of Examples 1-17, wherein the cannister pressurization component comprises an expandable and collapsible balloon.

Example 19 can include any of Examples 1-18, wherein the cannister pressurization component comprises an elastic diaphragm, a spring-coupled diaphragm, or a spring-coupled sliding piston.

Example 20 can include a perfusion system comprising: a housing containing a head unit configured to circulate a perfusate, the head unit comprising: an oxygenator disposed in the housing and configured to oxygenate the perfusate, the oxygenator configured to be fluidly coupled with an oxygen source and configured to receive oxygen therefrom; and a perfusion pump disposed in the housing and operably coupled with the oxygenator and configured to circulate the perfusate through the oxygenator, the perfusion pump comprising: a pump chamber for collecting oxygenated perfusate from the oxygenator; a valve fluidly coupled to the pump chamber, the valve configured to regulate pressure in the perfusion system; and a diaphragm operably coupled with the pump chamber and configured to pressurize the pump chamber, the diaphragm configured to circulate the perfusate through the system; a cannister releasably coupled to the housing, the cannister having a receptacle sized and shaped for receiving a target tissue; a cannister pressurization component fluidly coupled with the cannister and configured to maintain pressure in the cannister; and a cannula fluidly coupled with the head unit and the target tissue, the cannula configured to introduce the perfusate from the head unit to the target tissue in the cannister.

Example 21 can include Example 20, wherein the valve comprises: a first position, wherein the valve de-pressurizes the diaphragm to allow flow of oxygen from the pump chamber to the oxygenator; and a second position opposite the first position, wherein the valve pressurizes the diaphragm and induces circulation of oxygenated perfusate out of the pump chamber to the cannister via the cannula.

Example 22 can include a method of perfusing target tissue comprising: oxygenating perfusate liquid in an oxygenator; pumping the oxygenated perfusate liquid from the oxygenator to a de-pressurized pump chamber; pressurizing the pump chamber and pumping the oxygenated perfusate out of the pump chamber and through a cannula to the target tissue in a cannister; and oxygenating the target tissue and de-oxygenating the perfusate fluid.

Example 23 can include Example 22, further comprising pumping the de-oxygenated perfusate fluid from the target tissue to the oxygenator.

Example 24 can include any of Examples 22-23, wherein the target tissue is a heart, an organ, a limb, or other tissue.

Example 25 can include any of Examples 22-24, wherein the target tissue is coupled to an inner lid coupled to the cannister, the method further comprising releasing the inner lid from the cannister and removing target tissue with the inner lid while maintaining sterility of at least a portion of the cannister and the target tissue.

Example 26 can include any of Examples 22-25, further comprising coupling and decoupling the cannula to or from the target tissue.

Example 27 can include any of Examples 22-26 wherein pumping the oxygenated perfusate comprises pumping the oxygenated perfusate in a pulsatile flow.

In Example 28 the apparatuses, systems or methods of any one or any combination of Examples 1-27 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A perfusion system comprising:
a housing containing a head unit configured to circulate a perfusate, the head unit comprising:
an oxygenator disposed in the housing and configured to oxygenate the perfusate, the oxygenator configured to be fluidly coupled with an oxygen source and configured to receive oxygen therefrom; and
a perfusion pump disposed in the housing and operably coupled with the oxygenator and configured to circulate the perfusate through the oxygenator;
a cannister releasably coupled to the housing, the cannister having a receptacle sized and shaped for receiving a target tissue;
a cannister pressurization component fluidly coupled with the cannister and configured to maintain pressure in the cannister by acting as a pneumatic spring when pressurized by a gas pressure provided by a cannister pressure regulator;
a base plate adjacent the cannister pressurization component, the base plate for connecting the head unit to the cannister; and
a cannula fluidly coupled with the head unit and the target tissue, the cannula adjacent the base plate and configured to introduce the perfusate from the head unit to the target tissue in the cannister.

2. The system of claim 1, wherein the perfusion pump comprises:
a pump chamber for collecting oxygenated perfusate from the oxygenator;
a valve fluidly coupled to the pump chamber, the valve configured to regulate pressure in the pump chamber; and
a diaphragm operably coupled with the pump chamber and configured to pressurize the pump chamber, the diaphragm configured to circulate the perfusate through the system from the pump chamber to the cannister.

3. The system of claim 2, wherein the valve is fluidly connectable to the oxygen source and the pump diaphragm.

4. The system of claim 3, wherein the valve comprises at least one moveable element that can move alternately between:
a first position, wherein the valve de-pressurizes the diaphragm to allow flow of oxygen from the pump chamber to the oxygenator; and
a second position opposite the first position, wherein the valve pressurizes the diaphragm and induces circulation of oxygenated perfusate out of the pump chamber to the cannister via the cannula.

5. The system of claim 1, wherein the head unit further comprises a filter fluidly coupled with the oxygenator and configured to filter the perfusate.

6. The system of claim 1, wherein the oxygenator is configured to receive oxygen-depleted perfusate from the cannister, oxygenate the perfusate, and return the oxygenated perfusate to the target tissue via the cannula.

7. The system of claim 1, wherein the cannula is configured to be fluidly coupled to the target tissue and configured to support the weight of the target tissue when the target tissue is removed from the cannister.

8. The system of claim 1, wherein the base plate comprises a sealing element disposed between the cannister and the head unit, the base plate and sealing element forming a fluid tight seal therebetween.

9. The system of claim 1, further comprising an inner lid adjacent the base plate and separating the head unit from the cannister, the inner lid releasably coupled to the cannister,
wherein the inner lid comprises a wall defining an aperture therethrough, and wherein the cannula is disposed in the aperture, and
wherein the inner lid allows sterile access to the cannister, and wherein the inner lid supports weight of the target tissue.

10. The system of claim 1, wherein the cannister pressurization component comprises a diaphragm operably coupled with the cannister.

11. The system of claim 1, wherein the cannister pressurization component is configured to be pressurized by an external pressure source.

12. The system of claim 1, further comprising an oxygen source fluidly coupled to the head unit to provide the gas pressure.

13. The system of claim 12, wherein the cannister pressurization component is fluidly coupled to the oxygen source to allow pressurization thereof.

14. The system of claim 1, wherein the cannister pressurization component comprises an expandable and collapsible balloon.

15. The system of claim 1, wherein the cannister pressurization component comprises an elastic diaphragm, a spring-coupled diaphragm, or a spring-coupled sliding piston.
